(19) United States
(12) Patent Application Publication
(10) Pub. No.: US 2025/0252030 A1
(43) Pub. Date: Aug. 7, 2025

(54) PROVIDING A PROGRESS BAR WITH AN IMPROVED ESTIMATED TIME

(71) Applicant: INTERNATIONAL BUSINESS MACHINES CORPORATION, ARMONK, NY (US)

(72) Inventors: Thomas Jeffrey Solomon, Fordingbridge (GB); Yasmin Aumeeruddy, South Woodford (GB); Mark James Lawrence, Eastleigh (GB)

(21) Appl. No.: 18/602,457

(22) Filed: Mar. 12, 2024

(30) Foreign Application Priority Data
Feb. 1, 2024 (GB) 2401304.7

(51) Int. Cl. G06F 11/32; G06F 11/30; G06F 11/34

(52) U.S. Cl. CPC G06F 11/328; G06F 11/3055; G06F 11/3476

(57) ABSTRACT

A computer-implemented method for providing a progress bar with an improved estimated time of a job at a host system is disclosed. The method includes calculating an initial estimated time to completion value for a current task based on current available resources at the host system. The method includes determining any scheduled tasks at the host system scheduled in the initial estimated time to completion value for the current task and adjusting the initial estimated time to completion value of the current task based on an estimated impact of the scheduled tasks on the host resources.

### BACKGROUND

The present disclosure relates to providing an improved progress bar, and more specifically, to improving the accuracy of the estimated time in the progress bar.

Progress bars are a common user interface (UI) widget that provides a graphical control element to provide a visual indication to users of when a computing process is expected to complete. Progress bars are used to visualize the progression of an extended computer operation, such as a download, file transfer, or installation. Sometimes, the graphic is accompanied by a textual representation of the progress in a percent format.

The term “progress bar” is commonly used for the graphical control element; however, this is not restricted to a bar graphic and other forms of graphics such as disc representations may be used.

Progress bars are used commonly across computing, both locally and in the cloud. Examples of the use of progress indications are to help users during installations, as loading indicators, or in the cloud a progress indication may indicate progress through a provisioning task. Existing methods of implementing progress indications are flawed as they provide users with an inaccurate indication of expected completion time due to a lack of data on the hardware on which they are running.

One common implementation is to provide estimates of expected completion times based on an average hardware in place in the market today. This means that if a computer does not conform to this average, the expected time and the real time of completing that job can be quite different. For example, if a user has lower than average hardware specifications, the job would take longer than average. Consequently, the progress indication would fill up before the job has finished, which may cause users to believe the job has failed.

Another common implementation is a progress indication that is based on the number of tasks within the job, but tasks often have different sizes. This method also provides an inaccurate progress indication as it would estimate progress based on the quantity of tasks remaining instead of the time it would take for completion.

Poorly performing progress indications are an issue for users as it may lead to them believing that the job has failed. As a result, tasks might be manually aborted without completing the job and this could cause major systems errors and might even render the system in an unrecoverable state.

### SUMMARY

According to an aspect of the present disclosure there is provided a computer-implemented method for providing a progress bar with an improved estimated time of a task at a host system, said method comprising: calculating an initial estimated time to completion value for a current task based on current available resources at the host system; determining any scheduled tasks at the host system scheduled in the initial estimated time to completion value for the current task, wherein the scheduled tasks are not part of the current task; and adjusting the initial estimated time to completion value of the current task based on an estimated impact of the scheduled tasks on the host resources.

According to another aspect of the present disclosure there is provided a system for providing a progress bar with an improved estimated time of a task at a host system, comprising: a processor and a memory configured to provide computer program instructions to the processor to execute the function of the components; an initial estimated time component for calculating an initial estimated time to completion value for a current task based on current available resources at the host system; a scheduled tasks component for determining any scheduled tasks at the host system scheduled in the initial estimated time to completion value for the current task, wherein the scheduled tasks are not part of the current task; and an estimated time adjusting component for adjusting the initial estimated time to completion value of the current task based on an estimated impact of the scheduled tasks on the host resources.

According to a further aspect of the present disclosure there is provided a computer program product for providing a progress bar with an improved estimated time of a job at a host system, the computer program product comprising a computer readable storage medium having program instructions embodied therewith, the program instructions executable by a processor to cause the processor to: calculate an initial estimated time to completion value for a current task based on current available resources at the host system; determine any scheduled tasks at the host system scheduled in the initial estimated time to completion value for the current task, wherein the scheduled tasks are not part of the current task; and adjust the initial estimated time to completion value of the current task based on an estimated impact of the scheduled tasks on the host resources.

The computer readable storage medium may be a non-transitory computer readable storage medium and the computer readable program code may be executable by a processing circuit.

### BRIEF DESCRIPTION OF THE DRAWINGS

Embodiments of the present disclosure will now be described, by way of example only, with reference to the accompanying drawings.

FIG. 1 is a block diagram of an example embodiment of a system in accordance with embodiments of the present disclosure.

FIG. 2 is a flow diagram of an example embodiment of a method in accordance with embodiments of the present disclosure.

FIG. 3 is a flow diagram of an example embodiment of an aspect of the method in accordance with embodiments of the present disclosure.

FIG. 4 is a flow diagram of an example embodiment of another aspect of the method in accordance with embodiments of the present disclosure.

FIGS. 5A to 5C are schematic diagrams showing an example embodiment of stages of a progress bar in accordance with the present disclosure.

FIG. 6 is a graph showing an example embodiment of scheduled tasks' resource usage over estimated time in accordance with an aspect of the present disclosure.

FIG. 7 is a block diagram of an example embodiment of a system in accordance with embodiments of the present disclosure.

FIG. 8 is a block diagram of an example embodiment of a computing environment for the execution of at least some of the computer code involved in performing the present disclosure.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

Embodiments of a method, system, and computer program product are described for providing a progress bar with an improved estimated time of tasks at a host system. The term “progress bar” is defined as any visual graphical indication of progress of a task or job irrespective of whether it is represented as a bar or other form of visualization of progress. There may be one or more tasks that are required to be executed as part of a job and the progress bar may indicate the progress of the individual tasks and/or the overall job.

The method includes calculating an initial estimated time to completion value for a current task based on current available resources at the host system. This initial estimated time to completion may be based on metadata of previously executed instances of the task. In the situation where there are multiple tasks within a job, the metadata may be averaged for the tasks in the job. The method determines any scheduled tasks at the host system scheduled in the initial estimated time to completion value for the current task. This is determined based on metadata of monitored tasks and of scheduled tasks at the host system. The method adjusts the initial estimated time to completion value of the current task based on an estimated impact of the scheduled tasks on the host resources. This provides an improved accuracy of estimated time of completion of the current task.

Providing a progress bar with an improved estimated time of tasks at a host system is an improvement in the technical field of computer resource monitoring, planning, and information. Accurately predicting a time of execution of a task is a technical problem due to the possible variables involved for each host system.

The method uses of current available resources of the host system (for example, the CPU and network speed) and metadata of past tasks to calculate an initial estimated time to completion of a task for the progress bar.

The described method and system provide the ability to store metadata upon task completion which may be used to provide more accurate estimations of the time it takes to complete future tasks. The metadata may be saved in various formats and accessed by the described method. In one embodiment, metadata may be provided in a table structured format (for example, as comma-separated values (CSV)) which contains information on how long a job takes, the central processing unit (CPU) available when the task was run, the total network usage for the task, the sub-tasks within it, and the size of each task. This information is unique to each machine running the task and can be used to provide averages for the time that it takes that machine to complete tasks at any given time with the resources available. This metadata is then used to provide a more accurate progress indication to users for all future jobs, which can update whilst the job is running if there are changes to the resources available.

The method also monitors scheduled tasks at the host system and their average resource usage (for example, CPU utilization and network traffic) to update the initial estimated time to completion of the task to a truer value in a progress bar by taking account of tasks scheduled during the time of the initial estimated time to completion of the current task.

In this way the method further improves the estimated time to completion by additionally taking into consideration any planned scheduled tasks that may run on the machine whilst running the current task (referred to as the primary task), and the effect they may have on the current task's estimated time to completion. For example, applications are frequently updated and such updates may be a scheduled task. The metadata from these updates may be used to calculate the average length for the scheduled task completion. Leveraging this data for each subsequent scheduled task when updating may provide the user with a more accurate progress bars and therefore, a better indication of the status of when their application will be ready to use again.

The method may dynamically display of a message indicating what is causing a negative change in the estimated time to completion so users may take appropriate action.

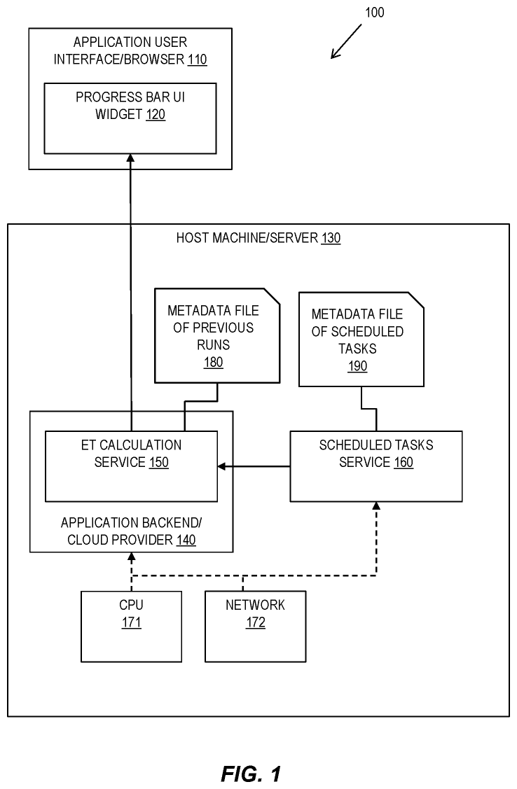

Referring to FIG. 1, a block diagram shows an example embodiment of a system 100 for providing a progress bar with an improved estimated time of tasks at a host system.

The system 100 includes an application user interface or browser 110 at which a progress bar user interface (UI) widget 120 may be provided.

The progress bar UI widget 120 may be provided within the presentation layer of an application, and is responsible for acting as the visual representation of progress to the user. Example implementations may be a progress bar compiled into the front-end of a locally running application or a progress bar running in a web application within a browser. The progress bar widget 120 may communicate with an estimated time (Et) calculation service 150 that provides the widget 120 with the data to present in the progress bar.

A host machine or server 130 may be provided at which a task is executed.

The Et calculation service 150 may be provided responsible for running continual ETC calculations whilst tasks are in progress. The Et calculation service 150 may maintain metadata 180 on previous task runs for use in the calculations. The Et calculation service 150 may be provided within an application backend or in a cloud provider 140. From the position of the Et calculation service 150. The Et calculation service 150 may have access to system resource metrics, for example, the CPU 171, network 172, and disk input/output operations per second (IOPS) 173. Example implementations of the Et calculation service 150 service may include: a function or class compiled into the backend of a locally running application; a RESTful service running on a web-server, or cloud provider which can be called by remote applications; or a service providing a WebSocket running on a server, or cloud provider which provides bi-directional communications continually to other remote applications.

A scheduled tasks service 160 may be provided in the same logical layer as the Et calculation service 150, but exists as a service on the host machine or server 130 and acts as a sidecar to the Et calculation service 150. The scheduled tasks service 160 is responsible for monitoring for processes that can be predicted to run regularly on the host system, logging their general performance impact on the machine, and maintaining findings in a metadata file of scheduled tasks 190. The scheduled tasks service 160 has access to host system resource metrics, for example, the CPU 171, and network 172.

When the Et calculation service 150 runs calculations for the estimated time to completion (ETC) of a task, it consults the scheduled tasks service 160 to provide any expected impacts. The scheduled tasks service 160 may then check its metadata to see if any scheduled tasks are due to run on the host machine before the ETC. If there is a scheduled task, the service may return the overall average CPU utilization as a percentage fraction the scheduled tasks have plus the amount of estimated data the schedule task plans to download. The Et calculation service 150 may then uses these return values to refine its ETC further.

Examples of scheduled tasks may include, but are not limited to, user cron jobs, disk defragmentation, virus scanning, system backups, and operating system updates.

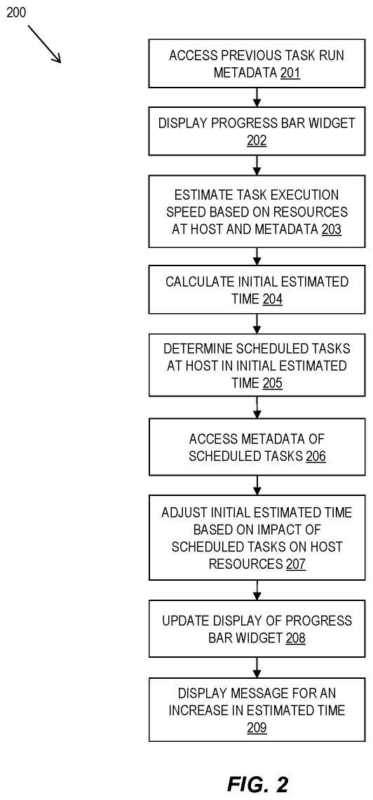

Referring to FIG. 2, a flow diagram 200 shows an example embodiment of a method for providing a progress bar with an improved estimated time of a task within a job at a host system. This example looks at a current task. The current task may be one or multiple tasks within a job for which a progress bar indicates the progress.

The method may access 201 metadata of previous runs of tasks. The metadata may provide resource usage of the previous runs of a task including, for example, CPU usage and network speed. The metadata may provide averages of resource usage of previous runs of a task or a group of tasks.

The method may display 202 a progress bar widget for the current task as a standalone task or as part of a job including multiple tasks. The display 202 may provide a visual indication of an estimated time to completion value of a task as estimated by the method below and may be updated when the estimated time to completion value is changed.

The method may estimate 203 a task execution speed based on resources at the current host and the task metadata. The method may calculate 204 an initial estimated time to completion value for a current task based on current available resources at the host system.

Calculating 204 an initial estimated time to completion value for a current task may include calculating initial processor estimated time for execution of the task based on metadata of previous tasks and current processor availability. Calculating 204 the initial estimated time to completion value for a current task may include calculating additional estimated time for downloads in the task based on size of download and current network speed.

The method may log the average CPU and network usage in previous task runs as metadata, and may compare the metadata that to the current availability of the CPU and network of the host machine to take into account the current load on the system and the affect that will have on the ETC providing an accurate value.

The method may determine 205 if there are any scheduled tasks at the host system scheduled in the initial estimated time to completion value for the current task. Scheduled tasks are external tasks carried out by the host system that are not part of the current task. Such scheduled tasks may deplete the available resources at the host affecting the execution speed of the current task. Metadata relating to the scheduled tasks may be accessed 206. Accessing metadata 206 may provide average resource usage by the scheduled tasks to update the estimated time to completion value of the current task.

The method may monitor the host system continually to identify regular scheduled tasks that are external and unrelated to any primary task for which the ETC is provided. The schedules tasks may be logged using their start time, average time to completion, CPU, and network usage.

It may then be determined if any identified scheduled tasks clash with the current primary task and then it may be calculated how much of the scheduled task will clash and how the effect of their required load on system resources will affect the primary task.

The method may adjust 207 the initial estimated time to completion value of the current task based on an estimated impact of the scheduled tasks on the host resources. The method may update 208 the display of the progress in the progress bar widget. This adjustment provides a truer ETC, taking into account tasks that are not associated to the primary task in any way.

Adjusting 207 the initial estimated time to completion value for a current task may include calculating additional processor estimated time for a scheduled task based on metadata of previous executions of scheduled tasks and current processor availability. Adjusting 207 the initial estimated time to completion value for a current task may include calculating additional estimated time for downloads in the scheduled task based on size of download and current network speed.

The method may also display 209 a message indicating a cause of a negative change in an estimated time to completion value allowing the user to act (e.g. allocate more memory, stop other tasks, etc.).

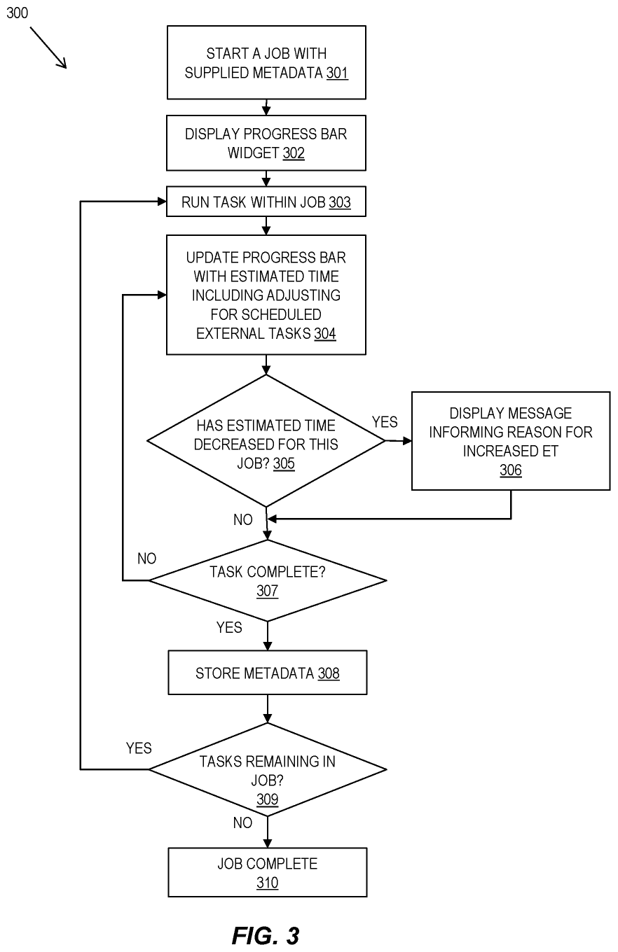

Referring to FIG. 3, a flow diagram 300 shows an example embodiment of a aspect of the described method for providing a progress bar with an improved estimated time of a job at a host system.

The method may start a job with supplied 301 metadata for tasks within the job. A progress bar widget may be displayed 302 to indicate the progress of the tasks within the overall job.

The method may run 303 a task within the job. The method may update 304 the progress bar with the estimated time to completion as adjusted for scheduled external tasks as described in relation to FIG. 2.

It may be determined 305 if the estimated time has decreased for the job. If so, the method may display 306 a message informing the reason for the increased estimated time. If there is no increase, the method may determine 307 is the task is complete. If the task is not complete, the method may loop to update 304 the progress bar. When the task is complete, the method may store 308 metadata relating to the execution of the task for future use.

The method may determine 309 if there are tasks remaining in the job. If so, the method may loop to run 303 the next task. Once there are no more tasks, the job is complete 310.

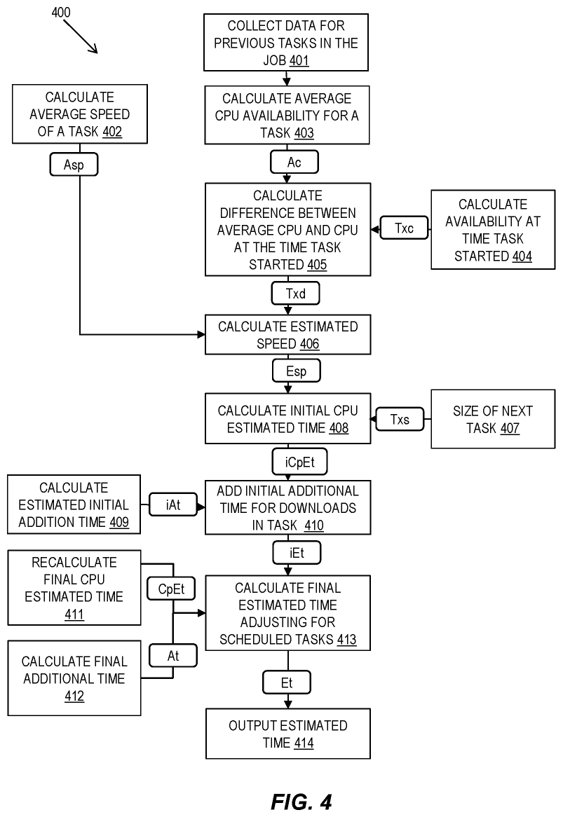

Referring to FIG. 4, a flow diagram 400 shows an example embodiment of a calculation of the estimated time of a task within a job. This flow may be carried out by the ‘Et Calculation Service’ which continually calculates an Et in real-time based on the information it is responsible for and can capture.

The method collects 401 data for previous tasks in the job, where J=job, t=task, n=number of tasks:

J={T1,T2 . . . Tn}
T1s=Size of task 1 (MB)
T1t=Time taken for task 1 (seconds)
T1c=CPU available during task 1(%)
T1sp=Speed of task completion for task 1 (MB/second)

The method finds the estimated time taken for a current task, e.g. Tx, including calculating 402 an average speed of a task and calculating 403 an average CPU availability for a task:

$$\begin{matrix}Asp = Average speed = ( T 1 sp + T 2 sp + … . + T nsp ) / n \\ Ac = Average CPU requirement = ( T 1 c + T 2 c + … . + Tnc ) / n\end{matrix}$$

The CPU availability at the time the current task is started is determined 404. The difference between the CPU available while task x is running (Txd) and the average CPU requirement of the previous tasks is calculated 405:

$$Txd = Txc / Ac$$

The estimated speed (Esp) is calculated 406 by multiplying the CPU availability difference (Txd) with the average speed of the previous tasks (Asp):

$$Esp = Txd * Asp$$

The initial estimated CPU time (iCpEt) is calculated 408 by diving the size of the task (Txs) 407 by the estimated speed (Esp):

$$iCpEt = Txs / Esp .$$

Initial Additional time (iAt) is calculated 409 if a task involves downloading content. The size of the content (Cxs) that is required by the task is divided by the download speed (Cxd) from the device's network connection:

$$i A t = Cxs / Cxd$$

The initial estimated time (iEt) that it would take to complete the task is calculated 410 by adding the additional time calculated at 409 on to the initial estimated CPU time (iCpEt):

$$i Et = iCpEt + At$$

For example:
Ac=80.11%
Asp=8.81 MB/sTxc=20% Txs=112 MB
Cxd=100 Mbps
Cxs=300 Mb

$$\begin{matrix}Txd = 20 \% / 80.11 \% = 33.27 \% \\ Esp = 33.27 \% * 8.81 MB / s = 2.93 MB / s \\ iCpEt = 112 MB / 2.93 MB / s = 38.19 seconds \\ iAt = 300 Mb / 100 Mbps = 3 seconds \\ iEt = iCpEt + 3 seconds = 41.19 seconds\end{matrix}$$

The scheduled tasks service is queried, passing it the initial estimated time iEt as a parameter. Two values are returned as: the estimated CPU utilization any scheduled tasks will have on the remaining Et (Scp); and the estimated amount of data (MB) any scheduled tasks will download during the remaining Et (Sds).

The final estimated CPU time (CpEt) is calculated 411 based on the CPU impact of scheduled tasks. This may be calculated by firstly multiplying the initial estimated CPU time (iCpEt) by two, then multiplying this value by the estimated scheduled tasks' CPU utilization (Scp), then adding back on the initial estimated CPU time (iCpEt). The reason for this is due to the rough linear relationship between CPU utilization and the time. If an initial time has been calculated assuming the CPU is 100% available, if scheduled tasks were due to start and are estimated to consume 50% CPU utilization, it may be roughly determined that the initial time would be twice as long, as the CPU is half of what it was expecting.

$$CpEt = i + CpEt + ( ( iCpEt * 2 ) * Scp )$$

The final additional time (At) is calculated 412 as the size of the content (Sds) that is required by the scheduled tasks, divided by the download speed (Cxd) from the device's network connection, added to the Initial Additional time (iAt):

$$At = iAt + ( Sds / Cxd )$$

The Estimated Time (Et) is then calculated 413 and output 414 as the final estimated CPU time (CpEt) added to the final additional time (At):

$$Et = CpEt + At$$

For example:
Scp=0.06 (6% CPU use across expected Scheduled tasks)
Cxd=100 Mbps
Sds=368 Mb

$$\begin{matrix}CpEt = 38.19 + ( ( 38.19 * 2 ) * 0.06 ) = 42.7 seconds \\ At = 3 + ( 368 / 100 ) = 8.68 second \\ Et = 42.7 + 8.68 = 49.38 seconds\end{matrix}$$

In this example, 8.19 seconds has been added to the initial Estimated time, to account for planned scheduled tasks.

The Et Calculation Service queries the scheduled tasks service, this service then returned values back to the Et calculation service, one being the percentage of CPU usage (as a fraction) which any found scheduled tasks are estimate to use within the Et calculated above, and the other being the estimated amount of data downloaded by the scheduled tasks within the Et calculated above. These values account for any expected scheduled tasks that are to begin, or are currently running within the Et time period and will negatively impact available resources to the primary task.

The output of the service and its use in the overall Et may only be considered a rough ballpark figure, which is a huge improvement on not considering scheduled tasks at all. A huge number of factors would have to be introduced into the calculations to provide a more accurate figure, which even then, would still be an estimate, because it is not possible to rely on all factors being constant.

To make this possible, the scheduled tasks service continually runs on the host machine monitoring all processes. Once it recognizes a pattern of a process running at a set time frequently and ending after a period of time, it will begin to log the time it starts, how long it takes to run, its CPU time, and the amount of data it downloads. Every run thereafter adds a new entry, and the average can be calculated later, removing outliers if desired.

When the Et calculation service queries the scheduled tasks service process, it runs the following steps:

Query the system for the current time.
currTime

Calculate the expected end time of the primary task using the current time and the Et it was provided by the Et calculation service.
priTaskEndTime=currTime+Et

Query the metadata it is responsible for to see if any scheduled tasks will start before the end time of the primary task. Concatenate multiple row entries to one by mean averaging out column values.

```
  list sTsWillRun = [ ]
  for (sT in csvMetadataFile) {
    if (sT.timeStart < priTaskEndTime) {
      if (sT in sTsWillRun) {
        // work on just one record and average values out
        sTsWillRun.replace(sT,
averageNewValuesWithExisting(sTsWillRun.get(sT), sT);
      } else {
        sTsWillRun.add(sT); // This scheduled task will run within Et
      }
    }
  }
```

Calculate how much of any scheduled task found will run within the estimated runtime of the primary task as a ratio.

```
for (sT in sTsWillRun) {
  if ((sT.timeStart + sT.Duration) < priTaskEndTime) {
    sT.ratio = 1; // entire scheduled task completes within primary Task
  } else {
    sT.ratio = (priTaskEndTime − sT.timeStart) / sT.duration
  }
  }
```

Use the ratio against the CPUTime to roughly estimate how much of each scheduled tasks CPU time will run into the primary task and accumulate it. If the scheduled task is currently running, nothing is done, because its CPU usage is already accounted for in the calculations made by the Et calculation service.

The total accumulated scheduled CPU time due to happen within the Et is then divided by the Et multiplied by the number of CPU cores available. This indicates an estimate of how much the CPU will be used by the scheduled tasks for the remainder of the primary task.

```
double totalSchTCPUTime = 0;
for (sT in sTsWillRun) {
  if (sT.timeStart > currTime ) {
    number actClashCpuTime = sT.CPUTime * sT.ratio;
    totalSchTCPUTime = totalSchTCPUTime + actClashCpuTime;
  }
}
```

double estCpuUsage=totalSchTCPUTime/(number of cores*Et);

Use the ratio against the TotalNetworkActivity to roughly estimate how much of each scheduled tasks network traffic will run into the primary task, and accumulate it.

```
number totalSchTMb = 0;
for (sT in sTsWillRun) {
  number actClashNetMb = sT.avTotalNetworkActivity * sT.ratio;
  totalSchTMb = totalSchTMb + actClashNetMb;
}
```

Both estCpuUsage and totalSchTMb are returned to the Et calculation service to include in its calculations.

For example, a table of the scheduled tasks metadata may be as follows.

| | | Dura- | CPUTime | TotalNetworkActivity |
|---|---|---|---|---|
| ProcessName | TimeStart | tion (s) | (s) | (MB) |
| OSUpda8 | 18:00 | 165 | 19 | 58 |
| VirusSkana | 12:00 | 3312 | 828 | 0 |
| KloudBakUp | 21:00 | 5400 | 1360 | 289 |
| OSUpda8 | 18:00 | 256 | 50 | 100 |

In this example, it is currently 17:56 (currTime), and the Et calculation service has calculated the Et is 14400 s (4 hours)
priTaskEndTime=17:56+4 hours=21:56
sTsWillRun=[OSUpda8, KloudBakUp, OSUpda8]
OSUpda8 (combined)=Duration (210.5), CPUTime (34.5), TotalNetworkActivity (79)
OSUpda8 (ratio=1), KloudBakUp (ratio=0.62)

$$\begin{matrix}( 34.5 * 1 ) + ( 1360 * 0.62 ) = 877.70 \\ estCpuUsage = 877.7 / 14400 = 0.06 \\ totalSchTMb = 79 + 289 = 368 MB\end{matrix}$$

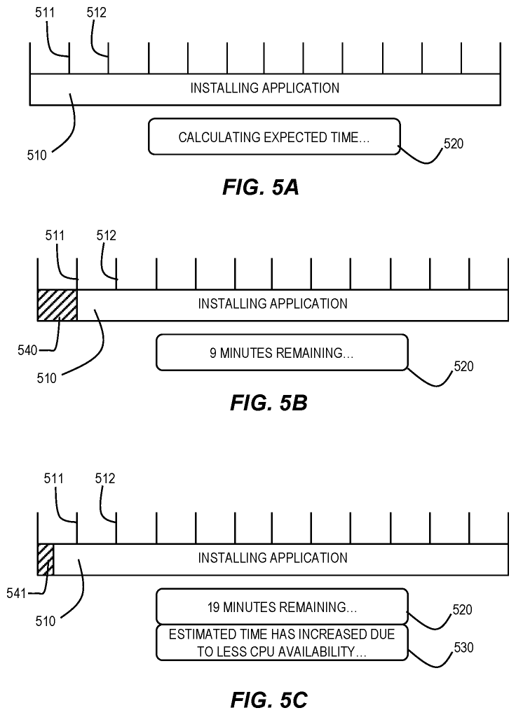

Referring to FIGS. 5A to 5C, example embodiments of stages of a progress bar 510 are shown. Lines denoting the task completion 511, 512 within a job are shown. A display 520 provides an explanation of a current status. In FIG. 5A, the progress bar 510 shows that the job of “installing application” has not yet started. The display 520 indicates that the system is “calculating expected time . . . .”.

In FIG. 5B, a shaded area 540 shows the progress of the application installation and the display 540 indicates “9 minutes remaining”. In FIG. 5C, the shaded area 541 has decreased in size and the display 520 indicates “19 minutes remaining . . . ”. An additional display 530 indicates “estimated time has increased due to less CPU availability”.

The presence of the dynamic message 530 provides a human-readable form of what factor in the calculations has caused an excessive increase in the Et. This is useful when running locally as a user (who may not feel comfortable diagnosing processes themselves in a task manager) can close resource consuming applications or cancel upcoming schedule tasks. This also brings value in the cloud arena, as it acts as an indicator to single tenant cloud owners that something is being utilized close to its maximum and may suggest that they need to subscribe to more resource.

The Et calculation service has full sight of what is causing the extended Et as it has access to all the data and runs all calculations, so requires a simple monitoring of the values to display the appropriate message when relevant.

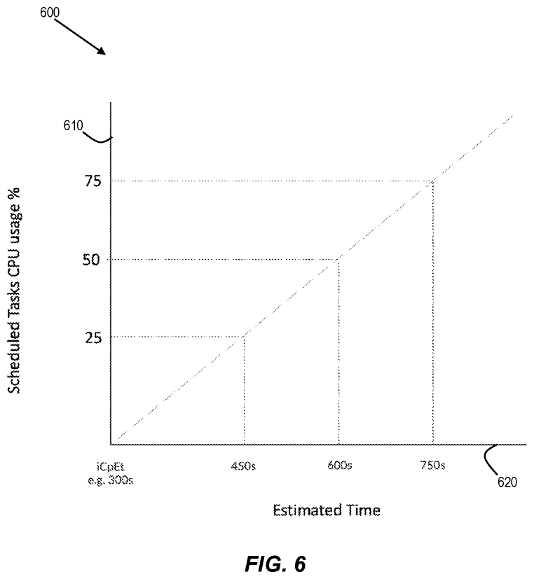

Referring to FIG. 6, a graph 600 shows an example relationship between scheduled tasks CPU percentage usage in one axis 610 against estimated time in the other axis 620. The graph 600 shows the linear relationship between CPU usage and the effect on the ETC, based on using the concept of 50% CPU available means twice the length of time. This is a rough estimate but gives a good estimated figure.

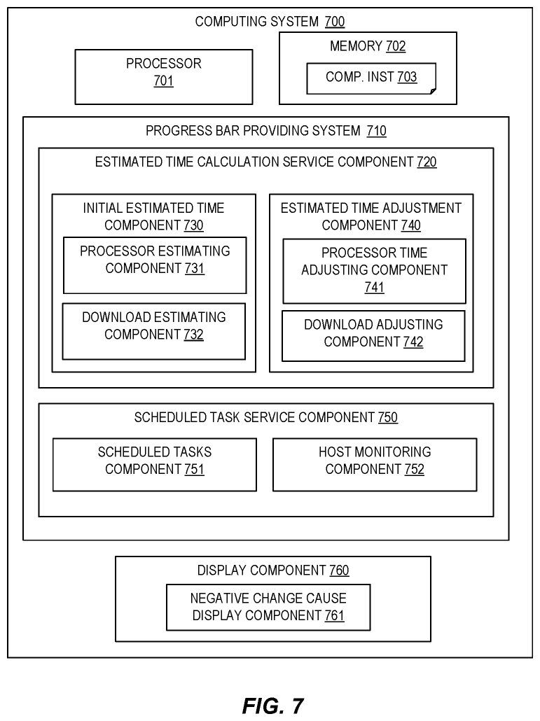

Referring to FIG. 7, a block diagram shows a computing system 700 on which aspects of the described system may be implemented. The computing system 700 may include at least one processor 701, a hardware module, or a circuit for executing the functions of the described components which may be software units executing on the at least one processor. Multiple processors running parallel processing threads may be provided enabling parallel processing of some or all of the functions of the components. Memory 702 may be configured to provide computer instructions 703 to the at least one processor 701 to carry out the functionality of the components.

A progress bar providing system 710 is shown on the computing system 700. The progress bar providing system 710 may provide a progress bar with an improved estimated time of a task at a host system. The computing system 700 may be one or more computing systems including the host system.

The progress bar providing system 710 includes an estimated time calculation service component 720 for running continual estimated time calculations whilst a task is in progress and including an initial estimated time component 730 and an estimated time adjusting component 740.

The initial estimated time component 730 is provided for calculating an initial estimated time to completion value for a current task based on current available resources at the host system.

The initial estimated time component 730 may include a processor estimating component 731 for calculating an initial processor estimated time for execution of the task based on metadata of previous tasks and a current processor availability. The initial estimated time component 730 may also include a download estimating component 732 for calculating additional estimated time for downloads in the task based on a size of a download and a current network speed.

The estimated time adjusting component 740 is provided for adjusting the initial estimated time to completion value of the current task based on an estimated impact of the scheduled tasks on the host resources.

The estimated time adjusting component 740 may include a processor time adjusting component 741 for calculating additional processor estimated time for a scheduled task based on metadata of previous executions of scheduled tasks and a current processor availability. The estimated time adjusting component 740 may include a download adjusting component 742 for calculating additional estimated time for downloads in a scheduled task based on a size of the download and a current network speed.

The progress bar providing system 710 includes a scheduled tasks service component 750 on or with access to a host machine and provided in communication with the estimated time calculation service component 720. The scheduled tasks service component 750 includes a scheduled tasks component 751 for determining any scheduled tasks at the host system scheduled in the initial estimated time to completion value for the current task. The scheduled task service component 750 includes a host monitoring component 752 for monitoring a host system continually to identify scheduled tasks, logging their start time, average time to completion, processor usage, and network usage.

The progress bar providing system 710 includes a display component 760 for displaying the estimated time to completion value of a task and updating the display when estimated time to completion value is changed and includes a negative change cause display component 761 for displaying a message indicating a cause of a negative change in the estimated time to completion value the display component includes displaying an estimated time to completion of multiple tasks that are involved in a job in a single display.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

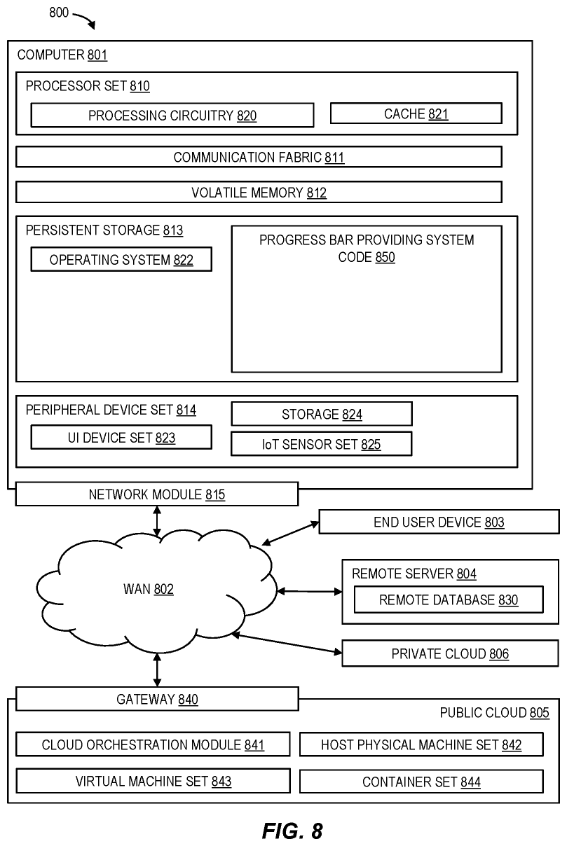

Referring to FIG. 8, computing environment 800 contains an example of an environment for the execution of at least some of the computer code involved in performing the inventive methods, such as a progress bar providing system code 850. In addition to block 850, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 850, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 850 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface-type operating systems that employ a kernel. The code included in block 850 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Improvements and modifications can be made to the foregoing without departing from the scope of the present disclosure.

What is claimed is:

1. A computer-implemented method for providing a progress bar with an improved estimated time of a task at a host system, the method comprising:
calculating an initial estimated time to completion value for a current task based on current available resources at the host system;
determining any scheduled tasks at the host system scheduled in the initial estimated time to completion value for the current task, wherein the scheduled tasks are not part of the current task; and
adjusting the initial estimated time to completion value of the current task based on an estimated impact of the scheduled tasks on the host resources.

2. The method of claim 1, further comprising:
displaying the estimated time to completion value of a task;
updating the display when estimated time to completion value is changed; and
displaying a message indicating a cause of a negative change in the estimated time to completion value.

3. The method of claim 2, further comprising:
displaying an estimated time to completion of multiple tasks that are involved in a job in a single display.

4. The method of claim 1, wherein calculating the initial estimated time to completion value for a current task includes:
calculating an initial processor estimated time for execution of the task based on metadata of previous tasks and a current processor availability.

5. The method of claim 4, wherein the metadata of previous tasks includes averages of previous tasks in a common job.

6. The method of claim 4, wherein calculating the initial estimated time to completion value for a current task includes:
calculating additional estimated time for downloads in the task based on a size of a download and a current network speed.

7. The method of claim 1, wherein adjusting the initial estimated time to completion value for a current task includes:
calculating additional processor estimated time for a scheduled task based on metadata of previous executions of scheduled tasks and a current processor availability.

8. The method of claim 7, wherein adjusting the initial estimated time to completion value for a current task includes:
calculating additional estimated time for downloads in a scheduled task based on a size of the download and a current network speed.

9. The method of claim 1, wherein adjusting the initial estimated time to completion value of the current task based on an estimated impact of the scheduled tasks on the host resources includes:
multiplying the initial estimated time (iCpEt) by two, then multiplying this value by the scheduled tasks' processor utilization (Scp), then adding back on the initial estimated time (iCpEt).

10. The method of claim 1, further comprising:
monitoring a host system continually to identify scheduled tasks, logging their start time, average time to completion, processor usage, and network usage.

11. A computer system for providing a progress bar with an improved estimated time of a task at a host system, the computer system comprising:
at least one processor;
at least one computer-readable storage media; and
instructions, collectively stored in the at least one storage media, for causing the at least one processor to perform the following computer operations:
calculate an initial estimated time to completion value for a current task based on current available resources at the host system;
determine any scheduled tasks at the host system scheduled in the initial estimated time to completion value for the current task, wherein the scheduled tasks are not part of the current task; and
adjust the initial estimated time to completion value of the current task based on an estimated impact of the scheduled tasks on the host resources.

12. The computer system of claim 11, further comprising instructions for causing the at least one processor to perform the following computer operations:
run continual estimated time calculations whilst a task is in progress.

13. The computer system of claim 11, further comprising instructions for causing the at least one processor to perform the following computer operations:
display the estimated time to completion value of a task;
update the display when estimated time to completion value is changed; and
display a message indicating a cause of a negative change in the estimated time to completion value.

14. The computer system of claim 13, further comprising instructions for causing the at least one processor to perform the following computer operations:
display an estimated time to completion of multiple tasks that are involved in a job in a single display.

15. The computer system of claim 11, further comprising instructions for causing the at least one processor to perform the following computer operations:
calculate an initial processor estimated time for execution of the task based on metadata of previous tasks and a current processor availability.

16. The computer system of claim 15, further comprising instructions for causing the at least one processor to perform the following computer operations:
calculate additional estimated time for downloads in the task based on a size of a download and a current network speed.

17. The computer system of claim 11, further comprising instructions for causing the at least one processor to perform the following computer operations:
calculate additional processor estimated time for a scheduled task based on metadata of previous executions of scheduled tasks and a current processor availability.

18. The computer system of claim 17, further comprising instructions for causing the at least one processor to perform the following computer operations:
calculate additional estimated time for downloads in the scheduled task based on a size of the download and a current network speed.

19. The computer system of claim 11, further comprising instructions for causing the at least one processor to perform the following computer operations:
monitor a host system continually to identify scheduled tasks, logging their start time, average time to completion, processor usage, and network usage.

20. A computer program product for providing a progress bar with an improved estimated time of a task at a host system, the computer program product comprising:
a set of one or more computer-readable storage media; and
program instructions, collectively stored in the set of one or more storage media, for causing a processor set to perform the following computer operations:
calculate an initial estimated time to completion value for a current task based on current available resources at the host system;
determine any scheduled tasks at the host system scheduled in the initial estimated time to completion value for the current task, wherein the scheduled tasks are not part of the current task; and
adjust the initial estimated time to completion value of the current task based on an estimated impact of the scheduled tasks on the host resources.
